(19) United States
(12) Patent Application Publication
(10) Pub. No.: US 2023/0398958 A1
(43) Pub. Date: Dec. 14, 2023

(54) INFORMATION PROCESSING DEVICE, INFORMATION PROCESSING METHOD, AND NON-TRANSITORY, COMPUTER-READABLE RECORDING MEDIUM

(71) Applicant: TOYOTA JIDOSHA KABUSHIKI KAISHA, Toyota-shi (JP)

(72) Inventors: Katsuharu TACHIBANA, Nagoya-shi (JP); Nana KIKUIRE, Shizuoka-ken (JP); Hiroshi INOUE, Nagoya-shi (JP)

(21) Appl. No.: 18/332,200

(22) Filed: Jun. 9, 2023

(30) Foreign Application Priority Data
Jun. 13, 2022 (JP) 2022-095244

(51) Int. Cl. B60R 25/20

(52) U.S. Cl. CPC B60R 25/2018

(57) ABSTRACT

An information processing device includes a memory; and a processor coupled to the memory. The processor is configured to acquire profile information corresponding to an OEM (Original Equipment Manufacturer) policy of a vehicle that is associated with a particular device, and in a case in which another information processing device that operates as a key of the vehicle is to be newly set, based on the profile information, present items, which can be utilized by the other information processing device, in selectable forms, and not present items, which cannot be utilized by the other information processing device, in selectable forms.

### CROSS-REFERENCE TO RELATED APPLICATION

This application is based on and claims priority under 35 USC 119 from Japanese Patent Application No. 2022-095244 filed on Jun. 13, 2022, the disclosure of which is incorporated by reference herein.

### BACKGROUND

### Technical Field

The present disclosure relates to an information processing device, an information processing method, and a non-transitory, computer-readable recording medium.

### Related Art

The use of automobiles as elements of transportation services is becoming popular, and it is anticipated that car sharing and other various services will increase and become even more widespread. Accompanying this trend, there is an increasing need for wireless digital key systems that make the transfer of physical keys unnecessary by using smartphones as keys of the automobiles.

Japanese Patent Application Laid-Open (JP-A) No. 2020-33707 for example is a technique relating to a wireless digital key system. JP-A No. 2020-33707 discloses an electronic key system for a vehicle that is provided with a portable device and an onboard device, and that carries out unlocking of the door locks of a vehicle and the like by establishing authentication of the portable device by the onboard device.

The CCC (Car Connectivity Consortium) has formulated standards relating to vehicle electronic key systems. Owner devices that are devices used by owners of vehicles, and friend devices that are devices supposing usage by friends or family of the owner, are prescribed in the standards formulated by the CCC.

In the standards formulated by the CCC, the profile information of a friend device must be compliant with the policy of the OEM (Original Equipment Manufacturer) of the vehicle. Authorities with respect to the vehicle are prescribed in the profile information. Accordingly, if the OEM policy of the vehicle that should be followed is changed, there is the possibility that the profile information that can be used also will change.

However, if the owner device has not recognized a change in the OEM policy of the vehicle, the owner device may end up granting a friend device an authority that is not compliant with the OEM policy of the vehicle.

### SUMMARY

An aspect of the disclosure is an information processing device including a memory; and a processor coupled to the memory. The processor is configured to acquire profile information corresponding to an OEM (Original Equipment Manufacturer) policy of a vehicle that is associated with a particular device, and in a case in which another information processing device that operates as a key of the vehicle is to be newly set, based on the profile information, present items, which can be utilized by the other information processing device, in selectable forms, and not present items, which cannot be utilized by the other information processing device, in selectable forms.

### BRIEF DESCRIPTION OF THE DRAWINGS

Exemplary embodiments of the present disclosure will be described in detail based on the following figures, wherein:

FIG. 1 is a drawing illustrating the schematic structure of a digital key system of a vehicle relating to an embodiment of the technique of the disclosure.

FIG. 2 is a block drawing illustrating hardware structures of an information processing device.

FIG. 3 is a block drawing illustrating an example of functional structures of the information processing device.

FIG. 4 is a flowchart illustrating the flow of information processing by the information processing device.

FIG. 5 is a drawing illustrating an example of forms of displaying items that are presented by the information processing device and are to be set for an information processing device.

### DETAILED DESCRIPTION

An example of an embodiment of the present disclosure is described hereinafter with reference to the drawings. Note that, in the drawings, the same reference numerals are given to structural elements and portions that are the same or equivalent. Further, the dimensional proportions in the drawings are exaggerated for convenience of explanation, and there are cases in which they differ from actual proportions.

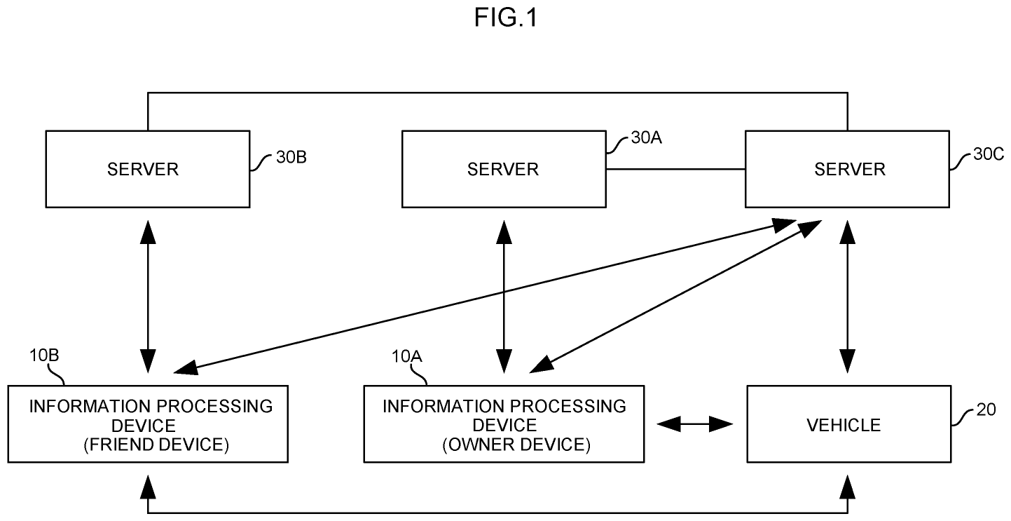

FIG. 1 is a drawing illustrating the schematic structure of a digital key system of a vehicle relating to the present embodiment.

The digital key system illustrated in FIG. 1 includes information processing devices 10A, 10B, a vehicle 20, and servers 30A, 30B, 30C.

The information processing device 10A is a device in which is stored a key (a digital key) for unlocking the locks of the vehicle 20 and for making driving possible. The information processing device 10A can be a portable device such as a smartphone, a wearable device or the like for example. The information processing device 10A communicates with the vehicle 20 by using near wireless communication technology such as BLE (Bluetooth® Low Energy), NFC (Near Field Communication), UWB (Ultra Wide Band), or the like. The information processing device 10A is an owner device in the “Digital Key” standards that are formulated by the CCC.

Similarly to the information processing device 10A, the information processing device 10B also is a device in which is stored a key (a digital key) for unlocking the locks of the vehicle 20 and for making driving possible. The information processing device 10B can be a portable device such as a smartphone, a wearable device or the like for example. The information processing device 10B communicates with the vehicle 20 by using near wireless communication technology such as BLE, NFC, UWB, or the like. The information processing device 10B can be a friend device in the “Digital Key” standards that are formulated by the CCC.

The information processing device 10A, 10B can be used as a digital key of the vehicle 20 by, for example, downloading and installing an application for causing the device to function as a digital key of the vehicle 20, and sharing information relating to the digital key with the vehicle 20.

The vehicle 20 carries out near wireless communication by any of the above-described, various near wireless communication techniques with the information processing devices 10A, 10B that function as digital keys of the vehicle 20, and executes processings relating to a digital key. The vehicle 20 executes locking processing and unlocking processing of the doors of the vehicle 20 as processings relating to a digital key. Further, the vehicle 20 executes the processing of starting-up the engine or the motor on the basis of an engine or motor start-up request from the information processing device 10A, 10B that operates as a digital key of the vehicle 20.

Note that, when the vehicle 20 receives an engine start-up request from the information processing device 10A, 10B, the vehicle 20 judges whether or not the information processing device 10A, 10B exists within the cabin of the vehicle 20. The reason for judging whether or not the information processing device 10A, 10B exists within the cabin of the vehicle 20 is in order to prevent starting-up of the engine in a state in which the information processing device 10A, 10B is outside of the vehicle cabin. The vehicle 20 judges whether or not the information processing device 10A, 10B exists within the cabin of the vehicle 20 by referring to the strength of the radio waves that are emitted from the information processing device 10A, 10B and are received by an antenna provided within the vehicle cabin.

In a case in which the information processing device 10B is added as a friend device of the vehicle 20, the information processing device 10B carries out communication with an antenna that is provided at a predetermined place within the cabin of the vehicle 20, and shares information relating to the digital key with the vehicle 20.

The server 30A is a server for providing, to the information processing device 10A, information for having the information processing device 10A function as a digital key of the vehicle 20. In accordance with a request from the information processing device 10A, the server 30A provides an application of a digital key, information relating to the digital key, and the like to the information processing device 10A as information for functioning as a digital key of the vehicle 20.

The server 30B is a server for providing, to the information processing device 10B, information for having the information processing device 10B function as a digital key of the vehicle 20. In accordance with a request from the information processing device 10B, the server 30B provides an application of a digital key, information relating to the digital key, and the like to the information processing device 10B as information for functioning as a digital key of the vehicle 20.

The servers 30A, 30B can be provided, for example, for each manufacturer of the information processing devices 10A, 10B. If the manufacturers of the information processing devices 10A, 10B are the same, information for functioning as a digital key may be provided from the same server.

The server 30C is a server that, in cooperation with the servers 30A, 30B, provides the information processing devices 10A, 10B and the vehicle 20 with information for having the information processing devices 10A, 10B function as a digital key of the vehicle 20. In accordance with a request from the information processing device 10A, 10B or the vehicle 20, or even if there is no request from the information processing devices 10A, 10B or the vehicle 20, the server 30C provides the vehicle 20 with information relating to the digital key, and the like, as information for functioning as a digital key of the vehicle 20.

Note that, although only one information processing device 10B that can become a friend device is illustrated in FIG. 1, in the present disclosure, there may be two or more information processing devices that can become friend devices. Further, in FIG. 1, although only one of each of the servers 30A, 30B, 30C is illustrated, each server may be structured by plural devices.

In a case in which the information processing device 10B is to be added as a friend device of the vehicle 20, based on the profile information corresponding to the OEM policy of the vehicle, the information processing device 10A relating to the present embodiment presents items that the information processing device 10B can utilize, in forms in which these items can be selected. On the other hand, in a case in which the information processing device 10B is to be added as a friend device of the vehicle, based on the profile information corresponding to the OEM policy of the vehicle, the information processing device 10A relating to the present embodiment does not present items that the information processing device 10B cannot utilize, in forms in which these items can be selected.

Due to the information processing device 10A executing such control, the information processing device 10A can be prevented from granting authorities, which are not compliant with the OEM policy of the vehicle, to the information processing device 10B.

Hardware structures of the information processing device 10A are described next.

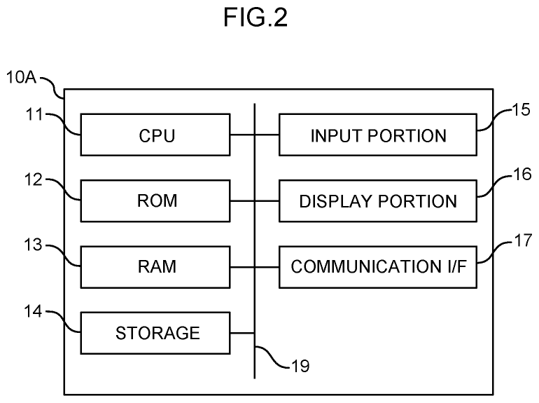

FIG. 2 is a block drawing illustrating hardware structures of the information processing device 10A.

As illustrated in FIG. 2, the information processing device 10A has a CPU (Central Processing Unit) 11, a ROM (Read Only Memory) 12 that is an example of a memory, a RAM (Random Access Memory) 13, a storage 14, an input portion 15, a display portion 16, and a communication interface (I/F) 17. These respective structures are connected so as to be able to communicate with one another via bus 19.

The CPU 11 that is an example of a hardware processor is a central computing processing unit, and executes various programs and controls the respective sections. Namely, the CPU 11 reads-out a program from the ROM 12 or the storage 14 that are examples of non-transitory recording media, and executes the program by using the RAM 13, which is an example of a memory, as a workspace. The CPU 11 carries out control of the above-described respective structures, and various computing processings, in accordance with programs recorded in the ROM 12 or the storage 14. In the present embodiment, a computer program that executes processings relating to digital keys of the vehicle 20 is stored in the ROM 12 or the storage 14.

The ROM 12 stores various programs and various data. The RAM 13 temporarily stores programs and data as a workspace. The storage 14 is structured by a storage device such as an HDD (Hard Disk Drive), an SSD (Solid State Drive), a flash memory or the like, and stores various programs, including the operating system, and various data.

The input portion 15 includes a pointing device such as a mouse or the like, and a keyboard, and is used in order to carry out various types of input.

The display portion 16 is a liquid crystal display for example, and displays various information. By using a touch panel type display therefor, the display portion 16 may function as the input portion 15.

The communication interface 17 is an interface for communication with other equipment such as the information processing device 10B, the vehicle 20, the server 30A, and the like, and standards such as, for example, Ethernet®, FDDI, Wi-Fi®, BLE, NFC, UWB or the like are used therefor.

At the time of executing the above-described computer program, the information processing device 10A realizes various functions by using the above-described hardware resources. The functional structures realized by the information processing device 10A are described.

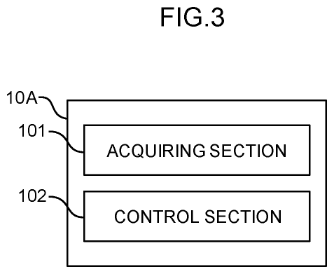

FIG. 3 is a block drawing illustrating an example of the functional structures of the information processing device 10A.

As illustrated in FIG. 3, the information processing device 10A has, as the functional structures thereof, an acquiring section 101 and a control section 102. The respective functional structures are realized by the CPU 11 reading-out a computer program stored in the ROM 12 or the storage 14, and executing the computer program.

The acquiring section 101 acquires, from the server 30A, profile information corresponding to the OEM policy of the vehicle 20 that is associated with the own device. The profile information prescribes authorities for the vehicle 20. The authority to the lock the doors, the authority to unlock the doors, the authority to start driving, the authority to operate equipment within the vehicle 20, and the like are authorities for the vehicle 20.

The time at which the acquiring section 101 acquires the profile information is not limited to a specific time. For example, the acquiring section 101 may acquire the profile information at the time when the information processing device 10B that can operate as a friend device becomes able to utilize a key.

Due to the information processing device 10A acquiring profile information at the time when the information processing device 10B becomes able to utilize a key, based on the latest profile information of the time when the information processing device 10B becomes able to utilize a key, the information processing device 10A can be prevented from granting another information processing device an authority that is not compliant with the OEM policy of the vehicle.

Further, the acquiring section 101 may acquire profile information in advance, before it is made such that the information processing device 10B that can operate as a friend device can utilize a key.

Due to the information processing device 10A acquiring profile information in advance, the processing at the time of setting authorities for the information processing device 10B can be shortened as compared with a case in which the profile information is not acquired in advance.

Moreover, the acquiring section 101 may acquire profile information at the time when a new component is added to the vehicle 20. Here, a component that assists driving of the vehicle, a component relating to autonomous driving of the vehicle, a component that controls equipment of the vehicle 20, and the like are examples of components. A car navigation system, a car audio system, and the like are examples of equipment of the vehicle 20.

Based on the latest profile information of the time when a new component is added, the information processing device 10A can be prevented from granting the information processing device 10B an authority that is not compliant with the OEM policy of the vehicle.

Note that the component may be a hardware component.

In a case in which the component is a hardware component, based on the latest profile information of the time when the new hardware component is added, the information processing device 10A can be prevented from granting the information processing device 10B an authority that is not compliant with the OEM policy of the vehicle.

Further, the component may be a software component. In a case in which the component is a software component, the acquiring section 101 may acquire the profile information at the time when the software component is updated.

In a case in which the component is a software component, based on the latest profile information of the time when the new software component is added, the information processing device 10A can be prevented from granting the information processing device 10B an authority that is not compliant with the OEM policy of the vehicle. Further, based on the latest profile information of the time when a software component is updated, the information processing device 10A can be prevented from granting the information processing device 10B an authority that is not compliant with the OEM policy of the vehicle.

The control section 102 carries out control relating to operations of the information processing device 10A. In detail, when another information processing device that operates as a key of the vehicle is newly set, based on the profile information acquired by the acquiring section 101, the control section 102 carries out control to present the items that can be utilized by that other information processing device, on the display portion 16 in selectable forms. Further, the control section 102 carries out control so as to not present items that cannot be utilized by that other information processing device, on the display portion 16 in selectable forms. The aforementioned other processing device is, for example, the information processing device 10B at the time of newly operating as a friend device.

As the control for not presenting the items, which cannot be utilized, on the display portion 16 and in selectable forms, the control section 102 may carry out control of presenting those items in a form that is different than that of the items that can be utilized. For example, the control section 102 may carry out control that presents the items that cannot be utilized in greyed-out states, as a form different than that of the items that can be utilized. Due to the control section 102 presenting those items in greyed-out states, it can be explicitly shown that those items cannot be utilized.

Further, as control for not presenting the items, which cannot be utilized, on the display portion 16 and in selectable forms, the control section 102 may carry out control such that those items are not presented on the display portion 16. By not presenting on the display portion 16 the items that cannot be utilized, setting of those items for the information processing device 10B can be prevented.

Further, the acquiring section 101 may acquire information relating to the OEM of the vehicle, and the control section 102 may, based on the information relating to the OEM of the vehicle 20 that is acquired by the acquiring section 101, carry out control that presents the items. The information relating to the OEM of the vehicle 20 may be, for example, an identifier of the OEM of the vehicle 20. The identifier of the OEM of the vehicle can include information relating to digital keys of the vehicle 20.

The profile of the digital key of the friend device must comply with the OEM policy of the vehicle, and the owner device determines the profile. Here, there is the possibility that the OEM policy of the vehicle that should be followed will be changed by the manufacturer of the vehicle 20 or of a component installed in the vehicle 20. If the OEM policy of the vehicle is changed, the owner device may end up granting a friend device an authority that is not compliant with the OEM policy of the vehicle.

Due to the information processing device 10A having a structure such as illustrated in FIG. 3, the information processing device 10A can be prevented from granting a friend device an authority that is not compliant with the OEM policy of the vehicle.

Operation of the information processing device 10A is described next.

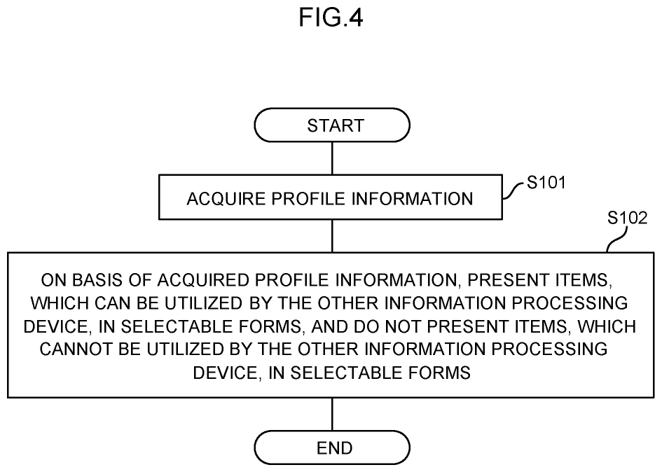

FIG. 4 is a flowchart illustrating the flow of information processing by the information processing device 10A. The information processing is carried out due to the CPU 11 reading-out a computer program from the ROM 12 or the storage 14, and expanding and executing the program in the RAM 13.

First, in step S101, the CPU 11 acquires profile information from the server 30A.

The time at which the CPU 11 acquires the profile information is not limited to a specific time. For example, the CPU 11 may acquire the profile information at a time when the information processing device 10B that can operate as a friend device becomes able to use the key. Further, the CPU 11 may acquire the profile information before the information processing device 10B that can operate as a friend device becomes able to use the key.

Further, the CPU 11 may acquire the profile information at a time when a new component is added to the vehicle 20. Here, the component may be a hardware component or may be a software component. In a case in which the component is a software component, the CPU 11 may acquire the profile information at the time of an update of the software component.

Following step S101, in step S102, in a case in which another information processing device that operates as a key of the vehicle is newly set, the CPU 11 carries out control, based on the profile information acquired in step S101, so as to present the items which that another information process device can utilize, in forms in which the items can be selected. Further, in step S102, the CPU 11 carries out control so as to not present the items that cannot be utilized by that another information processing device, on the display portion 16 in forms in which the items can be selected.

As control for not presenting, on the display portion 16 and in a form in which they can be selected, the items that cannot be utilized, the CPU 11 may carry out control so as to present those items in a form that is different than that of the items that can be utilized. For example, the CPU 11 may carry out control that presents the items that cannot be utilized in a greyed-out state, as a form that is different than the items that can be utilized.

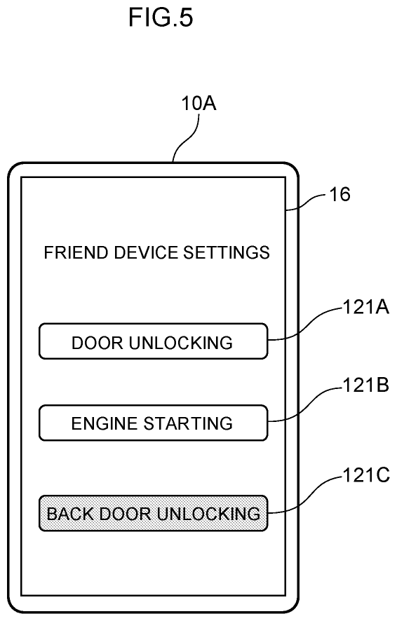

FIG. 5 is a drawing illustrating an example of forms of display of items that are presented by the information processing device 10A and that are to be set for the information processing device 10B. A state in which items 121A˜121C are presented on the display portion 16 of the information processing device 10A by an application relating to a digital key is illustrated in FIG. 5.

Items 121A, 121B are items that the information processing device 10B can utilize, and are displayed in selectable forms on the display portion 16. On the other hand, the item 121C is an item that the information processing device 10B cannot utilize, and is not displayed in a selectable form on the display portion 16. In other words, the item 121C is displayed on the display portion 16 in a form in which it cannot be selected. In the example illustrated in FIG. 5, due to the item 121C being displayed in a greyed-out state on the display portion 16, the item 121C is displayed on the display portion 16 in a form of being unable to be selected. Namely, in the OEM policy of the vehicle 20, locking of the backdoor of the vehicle 20 cannot be set for the information processing device 10B.

Note that, in the example illustrated in FIG. 5, the item 121C is displayed on the display portion 16 in a greyed-out state, but the present disclosure is not limited to this example. The information processing device 10A may control the display on the display portion 16 such that items that the information processing device 10B cannot utilize are not displayed on the display portion 16. Due to the information processing device 10A not displaying on the display portion 16 the items that cannot be utilized, setting of those items for the information processing device 10B can be prevented.

Due to the information processing device 10A executing the series of processings illustrated in FIG. 4, it is possible to prevent the information processing device 10A from granting an authority, which is not compliant with the OEM policy of the vehicle, to the information processing device 10B that is a friend device.

In a preferred example, the information processing device 10A acquires the profile information from the server 30A, and judges whether or not the profile information is compliant with the OEM policy of the vehicle. However, the present disclosure is not limited to this example. For example, the information processing device 10A may acquire the information of the OEM policy of the vehicle from the server 30C, and may distinguish the profile information that correspond to the acquired OEM policy of the vehicle, and may acquire the corresponding profile information from the server 30A. Further, for example, the information processing device 10A may select, from among profile information that are stored in advance, the profile information that correspond to the acquired OEM policy of the vehicle.

By acquiring the OEM policy of the vehicle from the server 30C, the information processing device 10A can distinguish and acquire the profile information that are based on the information of the latest OEM policy that is managed by the server 30C. Then, based on the profile information corresponding to the information of the latest OEM policy, the information processing device 10A can separately present the items that the friend device can utilize and the items that the friend device cannot utilize.

Note that any of various types of processors other than a CPU may execute the information processing that is executed due to the CPU reading-in software (a program) in the above-described respective embodiments. Examples of processors in this case include PLDs (Programmable Logic Devices) whose circuit structure can be changed after production such as FPGAs (Field-Programmable Gate Arrays) and the like, and dedicated electrical circuits that are processors having circuit structures that are designed for the sole purpose of executing specific processings such as ASICs (Application Specific Integrated Circuits) and the like, and the like. Further, the information processing may be executed by one of these various types of processors, or may be executed by a combination of two or more of the same type or different types of processors (e.g., plural FPGAs, or a combination of a CPU and an FPGA, or the like). Further, the hardware structures of these various types of processors are, more specifically, electrical circuits that combine circuit elements such as semiconductor elements and the like.

Further, the above embodiments describe forms in which the information processing program is stored in advance (is installed) in the ROM or the storage, but the present disclosure is not limited to this. The program may be provided in the form of being recorded on a non-transitory recording medium such as a CD-ROM (Compact Disk Read Only Memory), a DVD-ROM (Digital Versatile Disk Read Only Memory), a USB (Universal Serial Bus) memory, or the like. Further, the program may be in the form of being downloaded from an external device over a network.

The present disclosure was developed in view of the above-described points, and an object thereof is to provide an information processing device, an information processing method and a non-transitory, computer-readable recording medium that can prevent granting a friend device authorities that are not compliant with the OEM policy of the vehicle.

An aspect of the disclosure is an information processing device including a memory; and a processor coupled to the memory. The processor is configured to acquire profile information corresponding to an OEM (Original Equipment Manufacturer) policy of a vehicle that is associated with a particular device, and in a case in which another information processing device that operates as a key of the vehicle is to be newly set, based on the profile information, present items, which can be utilized by the other information processing device, in selectable forms, and not present items, which cannot be utilized by the other information processing device, in selectable forms.

In accordance with an aspect of the present disclosure, by not presenting the items, which cannot be utilized by the other information processing device, in selectable forms, it is possible to prevent granting the another information processing device an authority that is not compliant with the OEM policy of the vehicle.

In accordance with the present disclosure, there can be provided an information processing device, an information processing method and a non-transitory, computer-readable recording medium that can prevent a friend device from being granted authorities that are not compliant with the OEM policy of the vehicle.

What is claimed is:

1. An information processing device, comprising:
a memory; and
a processor coupled to the memory,
wherein the processor is configured to:
acquire profile information corresponding to an OEM (Original Equipment Manufacturer) policy of a vehicle that is associated with a particular device, and
in a case in which another information processing device that operates as a key of the vehicle is to be newly set, based on the profile information, present items, which can be utilized by the other information processing device, in selectable forms, and not present items, which cannot be utilized by the other information processing device, in selectable forms.

2. The information processing device of claim 1, wherein the processor is configured to acquire the profile information at a time when the other information processing device becomes able to utilize the key.

3. The information processing device of claim 1, wherein the processor is configured to acquire the profile information before the other information processing device becomes able to utilize the key.

4. The information processing device of claim 1, wherein the processor is configured to acquire the profile information at a time when a new component is added to the vehicle.

5. The information processing device of claim 4, wherein the component is a hardware component.

6. The information processing device of claim 4, wherein the component is a software component.

7. The information processing device of claim 6, wherein the processor is configured to acquire the profile information at a time of an update of the software component.

8. An information processing method comprising a processor executing processing comprising:
acquiring profile information corresponding to an OEM (Original Equipment Manufacturer) policy of a vehicle that is associated with a particular device; and
in a case in which another information processing device that operates as a key of the vehicle is to be newly set, based on the profile information, presenting items, which can be utilized by the other information processing device, in selectable forms, and not presenting items, which cannot be utilized by the other information processing device, in selectable forms.

9. A non-transitory recording medium storing a program that is executable by a computer to perform processing, the processing comprising:
acquiring profile information corresponding to an OEM (Original Equipment Manufacturer) policy of a vehicle that is associated with a particular device; and
in a case in which another information processing device that operates as a key of the vehicle is to be newly set, based on the profile information, presenting items, which can be utilized by the other information processing device, in selectable forms, and not presenting items, which cannot be utilized by the other information processing device, in selectable forms.
